(19) United States
(12) Patent Application Publication
(10) Pub. No.: US 2004/0096624 A1
(43) Pub. Date: May 20, 2004

(54) Synthetic building materials and methods for production

(76) Inventor: William Dennis Albright, Chula Vista, CA (US)

Correspondence Address: Lewis M. Brande, Esq., 5976 Falling Tree Lane, Alta Loma, CA, 91737, US

(21) Appl. No.: 10/294,536

(22) Filed: Nov. 14, 2002

(51) Int. Cl. B32B 3/12

(52) U.S. Cl. 428/116

(57) ABSTRACT

This invention describes synthetic redwood building material fashioned from a silicone mold that was impressioned with a genuine article of redwood and contains an outward layer of photoinitiated polyester clear gel coat, which is used only with the red pigmented gel coat in an intermediate layer of color-bearing polyester gel coat, a second intermediate layer of matting material, a third intermediate layer of honeycomb material and a rearward-facing layer. The invention also includes a method for making said synthetic redwood building material.

### FIELD OF INVENTION

This invention relates to the field of synthetic building materials, especially those composed of layers of different synthetic materials.

### 1. BACKGROUND OF THE INVENTION

Foamed synthetic resin materials, in which a foamed core blends in an outward direction into outer layers and is made denser relative to the foamed core, is well known in the art. The densified outer layers consist of the same synthetic resin as the foamed core. The densified outer layers can be made denser almost up to the theoretical maximum density limit for the material. These cellular synthetic resins are referred to as 37 structural foam material” or “integral foam material”.

It is known in the art how to create synthetic resin materials resembling wood. A sheet of synthetic resin is brought to an elevated temperature and fine furrows are embossed in the surface of the material using a cold embossing tool, such as a die press or an embossing roller. The texture or grain of wood is imitated in this manner.

Creating the fine furrows by embossing creates certain difficulties. For example, the required embossing pressure is so great that a uniform embossing pattern cannot be obtained. This is especially true if the plastic to be embossed has a thickness beyond a normal sheet thickness. Specifically, one cannot heat a sheet of synthetic resin to the point that the thermoplastic resin is soft enough to use at a low embossing pressure. There is also a danger that the material could cave in or become warped during the embossing process, especially if the material is a plate with a hollow profile. Hollow profile plates are not capable of retaining their overall flatness under such circumstances.

Plates of imitation wood have been produced out of structural or integral foam. Flow lines are produced during the simultaneous production of the foamed core and the denser outer layers. The flow lines, which are intended to imitate wood grain, are produced in the outer surface of the densified outer layers. The production of the flow lines involves pigmenting the outer layers and controlling the feeding head and the manner of casting.

In contrast to castings made of homogeneous plastic, imitation wood integral foam castings have the advantage that the specific gravity of the material and working properties of the material are similar to those of wood itself. Therefore, such integral foam cast bodies can be planed, milled, cut, drilled, bolted and nailed without cleaving or splitting the material. In injection molding, however, the shapes of the flow lines cannot be controlled to give the appearance of true wood grain. Additionally, the flow lines don't have the three dimensional look of the fine furrows of natural wood. Therefore, other imitation wood plates known in the art do not have the feel or appearance of natural wood.

To eliminate these disadvantages, imitation wood beams should be molded using molds or forms whose surfaces have a texture similar to that of a natural redwood. Such beams look very similar to natural redwood. The cost of producing them, however, is great. Also, the stain used in producing these beams is not an integral part of the beam and can be easily chipped or removed by mechanical forces, unlike natural redwood.

UV curing has been in industrial use for approximately 20 years, mainly in the ink and coating segments. Clear overprint coatings for paper and paperboard products are currently the largest UV-curable market. Beverage manufacturers such as Coors Brewing Co., in Golden Colo., apply UV-cured inks and coating to their rigid metal packaging (aluminum cans). But until now, UV-curing has not been actively pursued in the composites field for at least two reasons. First, UV rays must “see” what they are curing, making it useful for continuous processing but ruling out the manufacture of laminates. Second, UV rays cannot penetrate beneath the top layer of pigmented or colored material, such as “black” carbon.

The present invention avoids these disadvantages and provides additional advantages as well.

### 2. BRIEF DESCRIPTION OF THE DRAWINGS

FIG. 1 is a perspective view of the synthetic redwood building material.

FIG. 2 is a sectional view of a synthetic redwood building material.

FIG. 3 is a molding box with the genuine redwood article to be imitated in place.

FIG. 4 is the molding box with the silicone resin in place.

FIG. 5 is a perspective view of the molding box with the mechanical support in place on top of the silicone resin.

FIG. 6 is a perspective view of the silicone mold that has been lifted from the mold box displaying the mold cavity.

FIG. 7 is a cross-sectional view of a synthetic redwood piece in the mold cavity of FIG. 6.

### 3. SUMMARY OF THE INVENTION

The UV curing process is a chemical reaction. A photoinitiator is added to the resin formulation to absorb UV energy. Once exposed to the UV rays, the chemical structure of the photoinitiator breaks down into energized free radicals that actively seek new chemical bon sites within the resin mix. When the free radicals bond with other free radicals, the size of the polymer chain increases, causing the resin mix to polymerize into a solid state.

A light source is used to deliver the correct UV wavelength energy to initiate the curing action. One UV light source is an electrodeless-based mercury visible bulb. Another type available lamp system uses microwave energy to excite gases in the bulb envelope to create UV and visible light energy.

The primary objective of the present invention is to avoid the disadvantages of the other currently known synthetic building materials by providing a process for the production of a product that imitates the surface of many natural building materials, such as wood, stones or brick.

The product is made using a silicone mold that has been formed from a genuine article of building material, such that the mold retains the desired grain pattern of the original material. The product has an outer layer of clear, thermoplastic resin. Then a first intermediate layer of the same resin containing the desired color. Then a second, intermediate layer composed of one or more layers of synthetic matting material is attached to the first intermediate layer. Both the first and the second intermediate layers are applied to the surfaces that will be visible and are in contact with the silicone mold.

A third intermediate layer, composed of a mechanical support layer, such as a honeycomb core material or pegboard, is attached on the bottom side of the product and towards the inside of the second intermediate layer. The third intermediate layer is also attached on the top side of the product to the inside of a rear-facing member formed from one or more layers of synthetic matting.

Protruding attachment surfaces or flanges can be a part of the article that forms the silicone mold. If they are provided, these surfaces receive the same outer layer, as well as the first and second intermediate layers of the original product. After curing, a syntactic foam layer is applied, which fills the void between the second and third intermediate layers. The syntactic foam layer is also level with the rear-facing layer, to facilitate the attachment of the finished product to another surface.

The synthetic product of this invention will imitate the fine furrows of the grains of wood being imitated or the intricate surface detail of a rough stone face or the grainy, pitted texture of a brick. In addition, the color of the wood, stone or brick will be sealed in the material as an integral part of the finish and not simply added on, as a stain would be.

This invention is a synthetic building material wherein at least one of the outer surfaces has an outer layer composed of a UV-curable clear polyester gel coat. Attached to outer layer is a first intermediate layer composed of a color-bearing polyester gel coat that is UV curable. Attached to the first intermediate layer is a second intermediate layer consisting of one or more reinforcing matting materials. Attached to the second intermediate layer is a third intermediate layer composed of a honeycomb core or pegboard support material, with the cells (openings) of the honeycomb core or pegboard material facing the second intermediate layer. Finally, a rear-facing layer of one or more layers of matting material is applied to the surface of the honeycomb core or pegboard material containing the cells (openings).

This final product is unique from other current products by the fact that the outer layer imitates the texture of the piece of actual building materials, such as redwood, which is used to form the silicone mold from which the synthetic building material is made, more realistically than other products. In addition, the color-bearing layer is integrated into this product so that it becomes a part of the final product.

A further embodiment of this invention incorporates a method for producing a synthetic building material by:

(a) forming a silicone mold from all but one side of a piece of redwood;

(b) selecting a silicone that is compatible with a UV-curable photoinitiated polyester gel coat that is UV-curable;

(c) adding a second intermediate layer of reinforcing matting material;

(d) adding a third intermediate honeycombed layer; and

(e) adding a rear-facing layer at the back of the honeycomb layer.

All the above examples use photoinitated polyester resins and gel coats that are UV light cured. When the product leaves the mold, it is finished. The entire process is completely cured by UV lights.

### 4. DETAILED DESCRIPTION OF THE PREFERRED EMBODIMENT

It will be apparent to those skilled in the art that the essence of the present invention is a synthetic redwood building material (1) composed of an outer layer of a clear polyester gel coat (10). The outer layer of clear polyester gel coat (10) is attached to a first intermediate layer (15) that is a color-bearing polyester gel coat. The first intermediate layer (15) is UV cured. The first intermediate layer (15) is attached to a second intermediate layer or veil mat(20) of a mechanical support matting material. The second intermediate layer or veil mat (20) is attached a third intermediate honeycomb core layer (30). At the rear of the honeycomb core layer (30) is a rear-facing matting layer (40).

Thus, while the invention is described below in considerable detail, these descriptions represent various embodiments of the invention and should not be construed as limiting the invention.

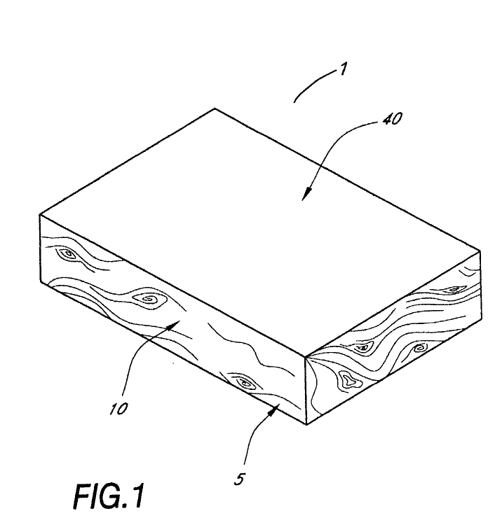

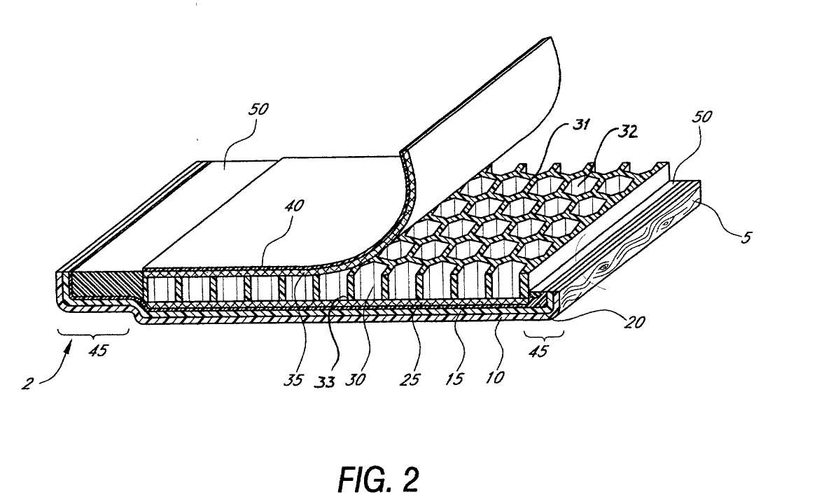

FIGS. 1 and 2 show a representative example of the synthetic building material of the instant invention.

FIG. 1 shows a “board-like” embodiment of the synthetic building material (1), wherein the outer layer (10) contains a pattern that imitates a redwood grain (5) found on the exposed layer of the synthetic building material (1), with the exception of a rear-facing layer (40) of the synthetic building material (1). The rear-facing layer (40) generally does not come in contact with the mold cavity (4).

FIG. 2 shows a second embodiment of the invention where projections (45) from the sides of the third intermediate layer (30) are attached to the synthetic building material (1). These projections (45) are comprised of the outer layer (10), a first intermediate layer (15), and the second intermediate layer (20). There can be one or more of these projections (45) on the synthetic building material (1).

These projections (45) each may have a core of syntactic foam (50). The syntactic foam (50) may be made from materials such as urethane foam. The syntactic foam (50) is attached to the second intermediate layer (20) and to the sides (31) of the third intermediate layer or honeycomb core (30). The syntactic foam (50) is approximately level with the rear-facing layer (40).

A third embodiment of the invention is also shown in FIG. 2, where a first veil mat (25) and a second veil mat (35) may be made from a porous matting material such as polyester. The first and second veil mat (25,35) can cover the top and bottom of the honeycomb core (or pegboard) material (30). The purpose of the first and second veil mat (25,35) is to prevent any of the material used to attach the rear-facing layer (40) and the second intermediate layer or veil mat (20) to the honeycomb layer (30) from being diverted into the cells (openings) (32) of the honeycomb core (30). The honeycomb core (30) may be made of a synthetic material, such as polypropylene or a natural material, such as cardboard.

A fourth embodiment is defined when the projections or flanges(45) from the sides (31) of the honeycomb core (30) are designed to be part of the synthetic building material (1). These projections (45) are composed of the outer layer (10), followed by the first intermediate layer (15) and then the second intermediate layer or veil mat (20). There can be one or more such projections or flanges (45). The projections (45) attach a filling of syntactic foam (50), such as polyurethane foam, to the second intermediate layer (20) and to the sides (31) of the honeycomb core (30). This layer of syntactic foam (50) is approximately level with the rear-facing layer (40) of the building material (10).

A fifth embodiment of this invention is also demonstrated in FIG. 2. In this embodiment, the honeycomb core (30) can be made from a synthetic material such as polypropylene or a natural material, such as cardboard. The honeycomb core (30) has a top (31) and a bottom side (33). On the top (31) and bottom sides (33), the honeycomb core cells (openings) (32) can be covered with a first veil mat (25) and a second veil (35) mat where the first and second veil mat (25,35) may be made from a porous matting such as polyester. The first and second veil mat (25,35) is then attached to the second intermediate layer or veil mat (20) and to the rear-facing layer (40), respectively.

The outer layer (10) and the first intermediate layer (15) will bond to each other in the mold, since they are essentially the same types of material. However, the second intermediate layer (20), the honeycomb core (30) and the rear-facing layer (40) must be attached by other means known in the art.

One such method involves applying a UV-curable photoinitiated polyester resin to the inside of the second intermediate layer or veil mat (20) as the second intermediate layer or veil mat (20) is put in place. The resin can then be UV-cured at this stage or cured after either the third honeycomb core (30) and/or the rear-facing layer (40) is put in place. As an option, the application of each remaining layer can be done by applying additional fiberglass resin, as when the honeycomb core (30) is UV transparent, i.e. made of polypropylene or other such material.

The rear-facing layer (40) or matting may also be applied with UV-curable photoinitiated polyester resin. The UV light will travel through the rear-facing layer (40) and the honeycomb core (30) to the second intermediate layer (20), thus curing fiberglass that has been saturated with the photoinitiated polyester resin at three levels simultaneously. Alternatively, the fiberglass saturated with photoinitiated polyester resin can be cured as it is applied.

If the projections or flanges (45) are incorporated in the synthetic building material (1), the UV-curable photoinitiated polyester resin used to attach the second intermediate layer (20) of reinforcing matting material must be cured before the syntactic foam (50) is applied.

In a sixth embodiment of the current invention, a color pigment is added to the first intermediate layer (15). The color is carefully matched to the redwood exemplar that is being imitated. The resulting piece of color-matched synthetic building material (1) can be used as decking material, siding for hot water spas, railing, framing and the like. Thus, the synthetic building material (1) can be treated like a piece of wood and can be planed, cut, routed and attached to a structure by nails, screws, rivets, and/or glue, as the circumstances demand.

The synthetic building material (1) has the advantage of imitating a wood grain (5) on all but one side of a piece of exemplar redwood. It can also be made to imitate the color and tint of the redwood. In addition, the rear-facing layer (40), which would normally be placed so that it's out of view in normal use, can be covered with a contact fabric that resembles redwood and can be painted the same color as the rest of the synthetic building material or workpiece (1).

A seventh embodiment of this invention can occur when the level of the syntactic foam (50) is raised to cover the rear-facing layer (40). This embodiment facilitates adding various finishes to the rear-facing layer (40) such as contact paper, stains and the like.

The matting that forms the second intermediate layer or veil mat (20) and the rear-facing layer (40) may be replaced with replacements that vary in thickness and material to give appropriate mechanical strength to the synthetic building material (1), especially for load bearing members. Fiberglass matting can be used in these two layers to increase load bearing strength.

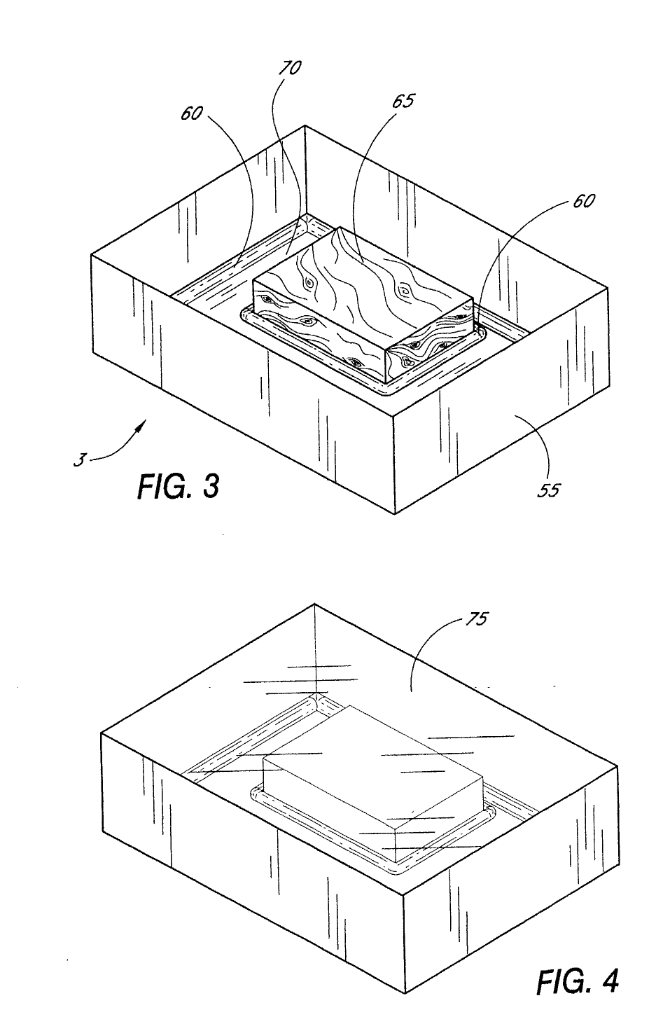

In FIG. 3, another aspect of this invention involves the molding process for making the synthetic building material (10). A mold box (3) is molded from a sturdy, non porous material, such as aluminum. The length, width and height of the mold box (3) are greater than that of a natural redwood workpiece (65). The natural redwood workpiece (65) is attached to one side of the box (3), preferably the largest side. All of the seams between the mold box (3) and the natural redwood piece (65) are treated with a material, such as virgin molding clay (60), to prevent a liquid silicone compound (75) from either intercalating or escaping.

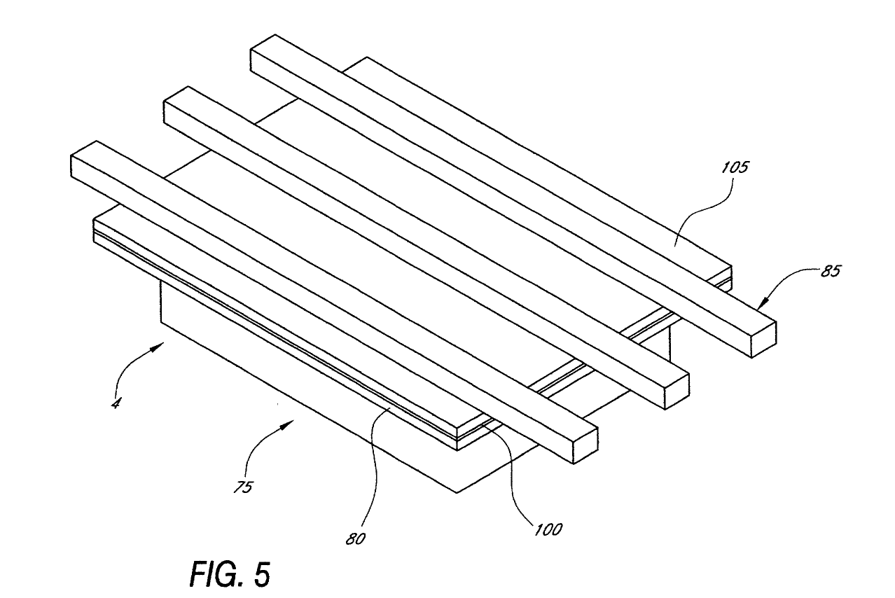

In FIG. 4, the box is filled with the liquid silicone compound (75). The silicone compound is compatible with the redwood colorized, UV-curable photoinitiated polyester resin gel coat. A photoinitiated polyester resin is also used in the laminate. The mold box (3) is filled with the liquid silicone compound (75) covering the top of the natural redwood workpiece (65) until the liquid silicone compound (75) is even with the tops of the sides of the mold box (3).

On top of the mold box (3), a ¼″ piece of pegboard (80), at least as long and as wide as the mold box (3), is positioned. The pegboard (80) has holes (90) so that the liquid silicone compound (75) will expand into the holes (90) as it cures. This expansion of the liquid silicone compound (75) will allow the silicone compound (75) to attach to the pegboard (80). The excess silicone can be removed after the silicone compound (75) is cured. Support materials, such as metal rods or wood rods or planks can be added to the pegboard (80).

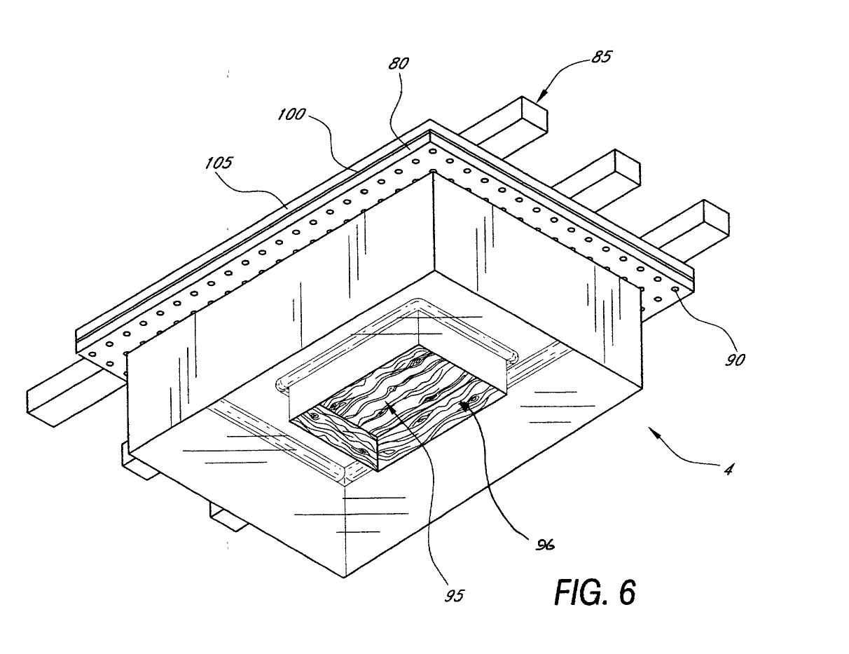

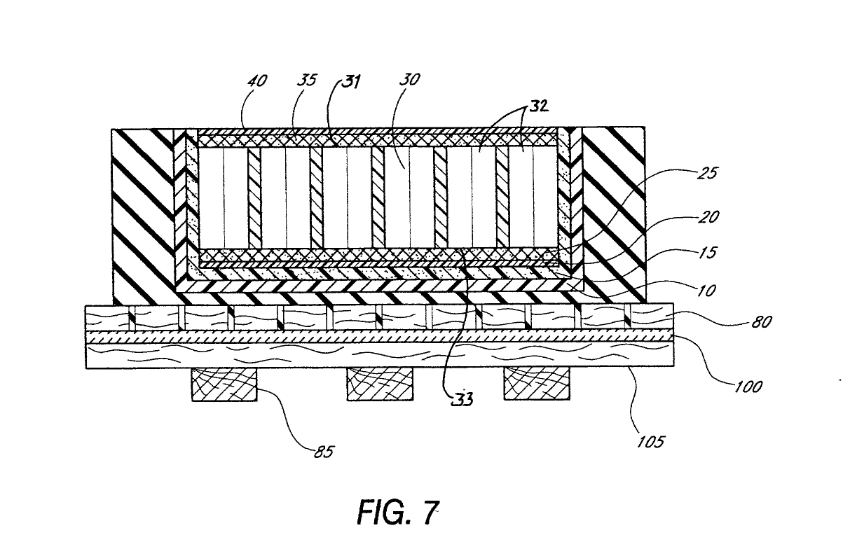

In FIGS. 5, 6 and 7, the support materials can be composed of a layer of fiberglass matting (100), a covering layer of plywood (105) and wooden beams (85) that are attached to each other to facilitate handling the mold (4) after the silicone (75) has cured. The pegboard (80) is connected to the mold (4) and the mold (4) is lifted out of the mold box (3). The outer layer of UV-curable photoinitiated polyester gel coat (10) is applied and cured with UV light. Then, the first intermediate layer of color-based pigmented polyester gel (15) is applied and UV cured. Next, the second intermediate layer of veil matting (20) is put in place and a UV-curable photoinitiated polyester resin is added to attach to the inside of the first intermediate layer (15) in sufficient amount to attach the second intermediate layer (20). Then the attachment resin can be UV cured before attaching the honeycomb layer (30). If the honeycomb layer (30) is transparent, it can be cured after the rear-facing layer (40) is added, as mentioned above. The cells (32) in the honeycomb core layer (30) can be covered in a fiberglass veil mat (25,35) on one or both sides of the honeycomb layer (30).

Finally, the rear-facing fiberglass layer (40) is applied by attaching a substance such as fiberglass and UV-curable photoinitiated polyester resin to the honeycomb layer (30), and to the rear-facing fiberglass layer (40). This rear-facing fiberglass layer (40) is made, typically, from the same materials as the second intermediate veil layer (20). However, the two layers don't have to be the same thickness or to be made of the same material.

If flanges (45) are to be used, they can be constructed using syntactic foam (50). The process for making the flanges (45) is that the outer layer (10), the first (15) and second (20) intermediate layers are put in place, but the honeycomb layer (30) does not fit on top of them due to the irregular size and shape formed by the flanges (45). The honeycomb layer (30) and the rear-facing layer (40) are put in place and cured. Then, syntactic foam (50) is applied to the void created by the process mentioned above. The syntactic foam (50) attaches to the second intermediate layer (20), to the sides (31) of the honeycomb core layer (30) and to the rear-facing fiberglass layer (40). The syntactic foam (50) is added in sufficient amount to be level with the outer surface of the rear-facing layer (40).

The syntactic foam (50) is then cured and the synthetic building material (1,2) is removed from the female mold (4). The synthetic building material (1,2) is thus formed and ready for use. The flanges (45) may be machined to form tongue and groove joint components, or simple lap joint components,

The present invention will now be illustrated by the following example. It will be apparent to those skilled in the art, the variety of substitutions possible for the materials and methods employed. Consequently the examples presented should be viewed as exemplary and not as limiting the invention to the particular materials and methods described.

### EXAMPLE A

### Making the Plug from Genuine Wood

Referring to FIG. 3, the mold box (3) for the instant molded synthetic redwood board (1,2) is fashioned from a piece of genuine redwood plug (65). To give the wood grain definition, a wire brush is used to accentuate the grain of the wood. A piece of flat hard surface stock (70) made from White Millimeen is fabricated longer and wider than the genuine redwood plug (65). The genuine redwood plug (65) is fastened to the White Millimeen with double-edge tape. A set of aluminum sides (55) is mechanically attached. The set of aluminum sides (55) forms a aluminum fence around the genuine redwood plug (65). The aluminum sides (55) exceed the height of the genuine redwood plug (65). A bead of Virgin Clay (60) is applied to all joints in the aluminum sides (55) and at the junction of the redwood plug and the surface of the surface stock (70). The Virgin Clay (60) prevents the silicone (75) from leaking through the joints, or in the case of the genuine redwood plug (65), from seeping between the genuine redwood plug (65) and surface stock (70). The dimensions of the surface stock (70) and the aluminum sides (55) determine the size of the female mold or form (4) which is defined by hardened silicone (75). The genuine redwood plug (65) and the interior surfaces of the mold (3) are cleaned with denatured alcohol in preparation of the addition of the silicone (75).

A mold release agent is applied to the genuine redwood plug (65) to help facilitate the release of the genuine redwood plug (65) from the silicone (75). The silicone (75) used for this process is manufactured by Silpak, Inc.—470 E. Bonita Ave., Pomona, Calif. 91767. The Trade Name of the release agent is MR-1500 (See MSDS—SILPAK INC. for complete description)

The A & B silicone components are mixed to a 10 to 1 ratio, degassed and poured into the mold box (3). Enough silicone (75) is added to cover the genuine redwood plug (65) and come to the top of aluminum sides (55).

With respect to FIG. 5, a tempered pegboard (80)is placed over the top of the mold box (3) and clamped into place. Silicone (75) that extrudes through the holes in the pegboard (90) is scrapped flush with a hand-held blade. After the silicone (75) has cured, a fiberglass mat (100), 1.5 oz. weight, is impregnated with fiberglass polyester resin that is MEKP cured, and is layered on top of the pegboard (80). A plywood backing (105), approximately ¾″ thick, and about the same size of the pegboard (80), is placed on top of the fiberglass mat (100) and resin. Additional supports (85) which may be 2″×2″ Pine beams, are placed on the plywood backing (105) and held in place by mechanical fastening or by glue to insure that the plywood backing (105) remains flat. After the silicone (75) has cured, which may take 24 hours or more, the female mold (4) is removed. The genuine redwood plug (65) remains attached to the plug box (3). The female mold (4) for the synthetic building material (1,2) is ready for use.

### EXAMPLE B

### Making Synthetic Redwood Parts from Silicone Molds

The female mold (4) is first wiped down with denatured alcohol immediately prior to adding the first gel coats. If the parts are to be redwood in color, then an outer layer (10) comprising a UV-curable photoinitated clear polyester gel coat is sprayed 0.016 inch (mils) thick inside the mold cavity (95).

The mold passes through a bank of ultraviolet lights, curing the UV-curable photoinitiated clear gel coat (10) within 5 minutes.

Marine Clear or UV-curable photoinitiated clear polyester gel coat, is only used in combination with red or heavily pigmented gel coats. All other colors of the gel coats are sprayed directly to the silicone mold surface (75), without the Marine Clear. The clear coat is a clear resin that may comprise 10 wt. % ,ethyl methacrylate, approximately 35 wt. % styrene monomer, and approximately 10-60 wt. % unsaturated polyester resin.

The UV-curable photoinitiated clear polyester gel coat is manufactured by Cook Composite and Polymer, 1412 Knox, No. Kansas City, Mo. 64116.

Product #UGPO5-3C001—Description: Clear Gel Coat.

Product #UGP61-8AH01—Gel Coat, Grey; No Marine Clear needed.

Product #UGP61-8RH01—Gel Coat, Redwood Product

#ULSDR-2T—UV Curable Laminating Resin—No Marine Clear needed.

All the above materials are photoinitiated UV curable.

After leaving the ultraviolet light chamber, a first intermediate layer(15) of pigmented colored gel coat is applied. The thickness of the first intermediate layer (15) is 0.004″ to 0.006″ (4 to 6 mils). The minimum acceptable thickness of the first intermediate layer (15) of pigmented colored gel coat is 0.004″ because thickness below 0.004″ do not maintain an adequate coverage of the base material. The maximum acceptable thickness of the first intermediate layer (15)of pigmented colored gel coat is 0.006″ because thickness greater than 0.006″ cause the gel coat to not become entirely cured by the UV light, as the UV light have difficulty in penetrating thicknesses greater than 0.006″. It is therefore desired to maintain a optimum thickness of 0.005″.

The first intermediate layer (15) of pigmented colored gel coat now passes through another bank of ultraviolet lights and is cured within 5 minutes. After exiting the bank of ultraviolet lights, a second intermediate layer or veil mat (20), is applied to the back of the first intermediate layer (15). FiberGlass Fiber Veil is manufactured by Owens Corning Veil UK LTD. P.O. Box 30 Liversedse WF158AA—Part #44J30FA1000C.

A UV-curable photoinitiated polyester resin is sprayed on top of the veil mat (20) until the veil mat is saturated with UV-curable photoinitiated clear polyester resin. The entrapped air under the veil mat (20) is removed by rolling or pressing, thereby forcing the veil mat (20) against the first intermediate layer (15) of hardened pigmented colored gel coat surface without any air entrapped. The female mold (4) now passes through another bank of ultraviolet lights and is cured within 5 minutes.

A piece of honeycomb core material (30), which may be manufactured in-house of cardboard and a first veil mat (25) made from a porous matting, is saturated with a UV-curable photoinitiated polyester resin on the top surface only. The same procedure is followed on the opposing side of the honeycomb core material (30) surface using a second veil mat (35) and is sprayed and saturated with a UV-curable photoinitiated polyester resin. While the fiberglass resin is still uncured, the veil mat (35) is placed over the honeycomb core material (30) and saturated with a photoinitiated polyester resin. All excess air is removed when placing the first and second veil mats(25,35) against the honeycomb core material (30). Honeycomb core material (30) may manufactured by Briteline Industries—627H Street #A-338, Chill Vista, Calif. 91910. Part #758124065 (No MSS required. Built in-house with same materials as listed above).

The female mold (4) passes through a final UV-curing light station. The honeycomb core material (30) and face sheets(25,35) are cured simultaneously by the UV light station.

All UV lights used in this process are standard Fusion UV lamps used in the industry and provided by Fusion UV Systems Inn. 910 Clapper Rd., Gathersburg, Md. 20878-1357. Model #F300S-30—Ultraviolet Curing System. The desired wavelength used by this process is 395 nm to 445 nm (nanometers), which is also known as the “UVV” range. The bulbs used for the production of UV light are mercury/gallium bulbs and are designated H, D, V, and Q.

What is claimed is:

1. A synthetic building material comprising:
a. an outer layer, said outer layer being made from a UV curable clear polyester gel coat, said outer layer being applied to an inside portion of a female mold;
b. a first intermediate color-bearing photoinitated gel coat layer, said first intermediate color-bearing photoinitated gel coat layer being attached to an inside of said outer layer;
c. a second intermediate layer or first veil mat, of one or more reinforcing matting materials, said second intermediate layer being attached to said inside of said first intermediate layer, said second intermediate layer being UV cured;
d. a third intermediate layer, said third intermediate layer being composed of a honeycomb material, said honeycomb material being attached to said second intermediate layer, said third intermediate layer having a second veil mat attached to said honeycomb core opposite said first veil mat, said third intermediate layer and second veil mat being UV cured to said second intermediate layer; and
e. a rearward-facing layer, said rearward facing layer being made from a matting material, said rearward facing layer being attached to the honeycomb material opposing said third intermediate layer, wherein said outer layer substantially imitates a grain pattern of a genuine piece of redwood building material.

2. The synthetic building material of claim 1, wherein said honeycomb core has a top side and a bottom side, said top side is covered with a first veil mat, and said bottom sides is covered with a second veil mat of said honeycomb core are each covered with a porous matting material, said second veil mat being attached to said rearward-facing layer.

3. The synthetic building material of claim 1, wherein said second intermediate layer, said third intermediate layer and said rearward-facing layer are attached using a UV-curable photoinitiated polyester resin, said UV-curable photoinitiated clear polyester resin being UV-curable.

4. The synthetic building material of claim 1, wherein said synthetic building material is fabricated in the form of a flat panel.

5. The synthetic building material of claim 1, wherein the rearward-facing layer is further finished.

6. The synthetic building material of claim 1, wherein the honeycomb core has porous matting on said top side and said bottom side, said porous matting being impregnated with a UV-curable photoinitiated clear polyester resin.

7. The synthetic building material of claim 1, wherein the honeycomb core is made from a synthetic material.

8. The synthetic building material of claim 1, wherein the honeycomb core is made from cardboard.

9. The synthetic building material of claim 1, wherein said outer layer has a thickness of 0.016 (16 mils).

10. The synthetic building material of claim 1 wherein said first intermediate layer has a thickness range of 0.004 to 0.006 inch (4 to 6 mils).

11. The synthetic building material of claim 1, wherein said UV light has a wavelength of 395 to 445 nm (nanometers).

12. A synthetic building material comprising:
a. a first intermediate color-bearing photoinitated gel coat layer, said first intermediate color-bearing photoinitated gel coat layer being attached to an inside portion of a female mold;
b. a second intermediate layer or first veil mat, of one or more reinforcing matting materials, said second intermediate layer being attached to said inside of said first intermediate layer, said second intermediate layer being UV cured;
c. a third intermediate layer, said third intermediate layer being composed of a honeycomb material, said honeycomb material being attached to said second intermediate layer, said third intermediate layer having a second veil mat attached to said honeycomb core opposite said first veil mat, said third intermediate layer and second veil mat being UV cured to said second intermediate layer; and
d. a rearward-facing layer, said rearward facing layer being made from a matting material, said rearward facing layer being attached to the honeycomb material opposing said third intermediate layer, wherein said outer layer substantially imitates a grain pattern of a genuine piece of redwood building material.

13. The synthetic building material of claim 12, wherein said honeycomb core has a top side and a bottom side, said top side is covered with a first veil mat, and said bottom sides is covered with a second veil mat of said honeycomb core are each covered with a porous matting material, said second veil mat being attached to said rearward-facing layer.

14. The synthetic building material of claim 12, wherein said second intermediate layer, said third intermediate layer and said rearward-facing layer are attached using a UV-curable photoinitiated polyester resin, said UV-curable photoinitiated clear polyester resin being UV-curable.

15. The synthetic building material of claim 12, wherein said synthetic building material is fabricated in the form of a flat panel.

16. The synthetic building material of claim 12, wherein the rearward-facing layer is further finished.

17. The synthetic building material of claim 12, wherein the honeycomb core has porous matting on said top side and said bottom side, said porous matting being impregnated with a UV-curable photoinitiated clear polyester resin.

18. The synthetic building material of claim 12, wherein the honeycomb core is made from a synthetic material.

19. The synthetic building material of claim 12, wherein the honeycomb core is made from cardboard.

20. The synthetic building material of claim 12, wherein said outer layer has a thickness of 0.016 (16 mils).

21. The synthetic building material of claim 12, wherein said first intermediate layer has a thickness range of 0.004 to 0.006 inch (4 to 6 mils).

22. The synthetic building material of claim 12, wherein said UV light has a wavelength of 395 to 445 nm (nanometers).

23. The synthetic building material of claim 12, wherein projections extend beyond said third intermediate layer, said projections being comprised of said first intermediate layer, and said second intermediate layer.

24. The synthetic building material of claim 23, wherein said projections have a core of syntactic foam attached therein, said syntactic foam being attached to said second intermediate layer and to sides of said third intermediate layer or honeycomb core, said syntactic core being approximately level with said rearward-facing layer.

25. The synthetic building material of claim 23 and 24, wherein said projections may be formed to a provide tongue and groove interlocking fit.

26. The synthetic building material of claim 23 and 24, wherein said projections may be formed to provide a lap joint fit.

27. A method of producing a synthetic building material, the method comprising the steps of;
a. providing a female mold, said female mold being fabricated from silicone;
b. cleaning said female mold with denatured alcohol;
c. spraying an outer layer of a UV-curable photoinitiated clear gel coat;
d. directing UV radiation to said outer layer of UV-curable photoinitiated clear gel coat to cure said outer layer;
e. applying a first intermediate layer of pigmented colored gel coat to said outer layer;
f. directing UV radiation onto said first intermediate layer of pigmented colored gel curing said first intermediate layer;
g. placing a first veil mat onto said first intermediate layer;
h. spraying a UV-curable photoinitiated polyester resin onto said first veil mat;
i. rolling said first veil mat saturated with said UV-curable photoinitiated polyester resin to eliminate entrapped air;
j. directing UV radiation onto said UV-curable photoinitiated polyester resin saturated first veil mat to cure said first veil mat;
k. placing a honeycomb core against said first veil mat;
l. applying a UV-curable photoinitiated polyester resin saturated second veil mat on said honeycomb core;
m. placing a rear-facing fiberglass layer saturated with UV-curable photoinitated polyester resin onto said second veil mat on top of said honeycomb core;
n. directing UV radiation to said using UV light to said rear-facing fiberglass layer saturated with UV-curable photoinitated polyester resin, said UV-curable photoinitiated polyester resin saturated second veil mat, and said honeycomb core curing said rear-facing fiberglass layer, said second veil mat and said honeycomb core to said first veil mat; and
o. removing a finished synthetic building material from said female mold.

28. The method of claim 27 wherein said outer layer is cured in about five minutes.

29. The method of claim 27 wherein said first intermediate layer is cured in about five minutes.

30. The method of claim 27 wherein said first veil mat is cured in about five minutes.

31. The method of claim 27 wherein said honeycomb core, said second veil mat, and said rear-facing outer layer is cured in about five minutes.

32. The method of claim 27 wherein said first intermediate layer is applied in a thickness of 0.004 to 0.006 inch (4 to 6 mils).

33. The method of claim 12 where the UV light is in a wavelength spread from 395 to 445 nanometers.

34. The method of claim 27 where the UV light is produced from “UVV” bulbs selected from the group of H, D, V, and G.

35. A method of producing a synthetic building material, the method comprising the steps of;
a. providing a female mold, said female mold being fabricated from silicone;
b. cleaning said female mold with denatured alcohol;
c. applying a first intermediate layer of pigmented colored gel coat to silicone mold;
d. directing UV radiation onto said first intermediate layer of pigmented colored gel curing said first intermediate layer;
e. placing a first veil mat onto said first intermediate layer;
f. spraying a UV-curable photoinitiated polyester resin onto said first veil mat;
g. rolling said first veil mat saturated with said UV-curable photoinitiated polyester resin to eliminate entrapped air;
h. directing UV radiation onto said UV-curable photoinitiated polyester resin saturated first veil mat to cure said first veil mat;
i. placing a honeycomb core against said first veil mat;
j. applying a UV-curable photoinitiated polyester resin saturated second veil mat on said honeycomb core;
k. placing a rear-facing fiberglass layer saturated with UV-curable photoinitatcd polyester resin onto said second veil mat on top of said honeycomb core;
l. directing UV radiation to said using UV light to said rear-facing fiberglass layer saturated with UV-curable photoinitated polyester resin, said UV-curable photoinitiated polyester resin saturated second veil mat, and said honeycomb core curing said rear-facing fiberglass layer, said second veil mat and said honeycomb core to said first veil mat; and
m. removing a finished synthetic building material from said female mold.

36. The method of claim 35 wherein said outer layer is cured in about five minutes.

37. The method of claim 35 wherein said first intermediate layer is cured in about five minutes.

38. The method of claim 35 wherein said first veil mat is cured in about five minutes.

39. The method of claim 35 wherein said honeycomb core, said second veil mat, and said rear-facing outer layer is cured in about five minutes.

40. The method of claim 35 wherein said first intermediate layer is applied in a thickness of 0.004 to 0.006 inch (4 to 6 mils).

41. The method of claim 35 where the UV light is in a wavelength spread from 395 to 445 nanometers.

42. The method of claim 35 where the UV light is produced from “UVV” bulbs selected from the group of H, D, V, and G.
